(19) United States
(12) Patent Application Publication
(10) Pub. No.: US 2025/0216667 A1
(43) Pub. Date: Jul. 3, 2025

(54) Angled Shoe Interface for Night Vision Devices

(71) Applicant: Jo Won Seuk, Whispering Pines, NC (US)

(72) Inventor: Jo Won Seuk, Whispering Pines, NC (US)

(21) Appl. No.: 18/648,688

(22) Filed: Apr. 29, 2024

Related U.S. Application Data
(60) Provisional application No. 63/462,881, filed on Apr. 28, 2023.

(51) Int. Cl. G02B 23/12

(52) U.S. Cl. CPC G02B 23/125

(57) ABSTRACT

The angled shoe interface provides a mechanical interface for connecting night vision devices to the sliding carriage of a conventional night vision device mount to selectively orient the line of sight of the night vision device relative to the longitudinal axis of the mount rail. Each angled shoe interface has a wedge-shaped body with differing angled top and bottom surfaces to provide the desired angular orientation of the line of sight of night vision device relative to the longitudinal axis of the mount rail. Individual users can interchange different angled shoe interfaces to properly orient the night vision device's line of sight based on the shape and size of the user's head and how the helmet is donned.

### CROSS-REFERENCE TO RELATED APPLICATIONS

This application claims the benefit of U.S. Provisional Patent Application, Ser. No. 63/462,881 filed Apr. 28, 2023, the disclosure of which is hereby incorporated by reference.

This invention relates to shoe interfaces for night vision devices and helmet mounts, and in particular, angled shoe interfaces properly orienting the night vision device relative to the mount rail.

### BACKGROUND AND SUMMARY OF THE INVENTION

Conventional helmet mounted night vision devices use adjustable mounts, such as the one available from Wilcox Industries Corp, to detachably connect the night vision device to the front of the helmet. These mounts also allow the user to selectively position the night vision device relative to the user's eyes and face. In conventional helmet mounted night vision setups, the mounts allow the user to pivot the night vision devices between a stowed position and an operational position. The mounts allow the night vision device to be moved and positioned adjusting both the height of the night vision device up and down and the distance of the night vision device toward and away from the user's eye when the night vision device is in the operational position. Heretofore, conventional mounts have only allowed linear adjustments up and down and back and forth and have not allowed the angular orientation of the night vision device to be selected or adjusted relative to the wear's eye. Consequently, conventional helmet mounted night vision setups often do not properly align with the wear's line of sight due to the size and shape of the wearer's head and the fit of the helmet atop the wearer's head.

The angled shoe interface of this invention provides a mechanical interface for connecting night vision devices to the sliding carriage of a conventional NVD mount to selectively orient the line of sight of the NVD relative to the longitudinal axis of the mount rail. Each angled shoe interface has a wedge-shaped body with differing angled top and bottom surfaces to provide the desired angular orientation of the line of sight of NVD relative to the longitudinal axis of the mount rail. Individual users can interchange different angled shoe interfaces to properly orient the NVD's line of sight based on the shape and size of the user's head and how the helmet is donned.

The above-described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a side view of a helmet mounted night vision device using a conventional shoe interface to connect the night vision device to the helmet mount (Prior Art);

FIG. 2 is a view of a helmet mounted night vision device using an exemplary embodiment of the angled shoe interface of this invention to connect the night vision device to the helmet mount;

FIG. 3 is an exploded side view of the helmet mounted night vision device and angled shoe interface of FIG. 2;

FIG. 4 is a perspective view of the angled shoe interface of FIG. 2;

FIG. 5 is a top view of the angled shoe interface of FIG. 4;

FIG. 6 is a perspective view of an alternative embodiment of the angled shoe interface of this invention;

FIG. 7 is a front plan view of the angled shoe interface of FIG. 4;

FIG. 8 is a side plan view of the angled shoe interface of FIG. 4;

FIG. 9 is a rear plan view of the angled shoe interface of FIG. 4;

FIG. 10 is a front plan view of the angled shoe interface of FIG. 6;

FIG. 11 is a side plan view of the angled shoe interface of FIG. 6;

FIG. 12 is a rear plan view of the angled shoe interface of FIG. 6;

FIG. 13 is an exploded side view of the helmet mounted night vision device and a third exemplary embodiment of the angled shoe interface of this invention;

FIG. 14 is a perspective view of the angled shoe interface of FIG. 13;

FIG. 15 is an end plan view of the angled shoe interface of FIG. 14;

FIG. 16 is a side plan view of the angled shoe interface of FIG. 14;

FIG. 17 is an end plan view of a fourth exemplary embodiment of the angled shoe interface of this invention; and

FIG. 18 is a side plan view of the angled shoe interface of FIG. 17.

### DETAILED DESCRIPTION OF THE INVENTION

In the following detailed description of the preferred embodiments, reference is made to the accompanying drawings that form a part hereof, and in which are shown by way of illustration specific preferred embodiments in which the invention may be practiced. These embodiments are described in sufficient detail to enable those skilled in the art to practice the invention, and it is understood that other embodiments may be utilized, and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims. At least one specification heading is required.

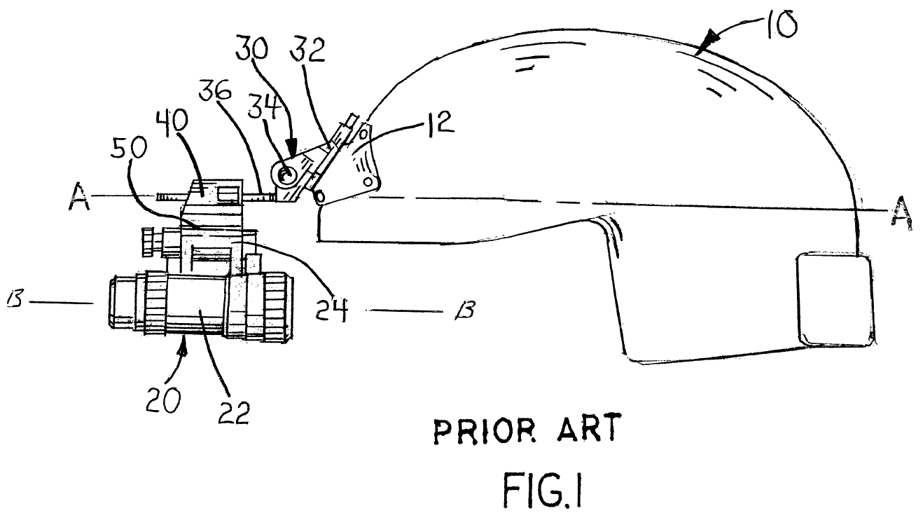

Referring now to the drawings, FIG. 1 shows a conventional helmet mounted night vision device setup, which represents the current state of the art for military, law enforcement and civilian use. The night vision device setup includes a helmet 10, a night vision device (NVD) 20, and an NVD Mount 30. As illustrated, helmet 10, NVD 20 and NVD mount 30 are all conventional design and function and commonly used in helmet mounted night vision setups. NVD 20 is shown as a conventional dual tube night vision google, such as one available from L3 Harris Technologies, Inc. of Melbourne Florida. Helmet 10 is the host component worn by the user. Helmet 10 is shown as a conventional non-ballistic tactical or “bump” helmet, such as those available from Team Wendy of Cleveland, Ohio, or Hard Head Veterans of Sweetwater, Texas. Helmet 20 includes a standard shroud 12 affixed to the front of the helmet. Shroud 12 provides the interface for connecting mount 30 to helmet 10. Mount 30 is shown as a conventional NVD mount, such as those G24 available from Wilcox Industries Corp. Of Newington, New Hampshire. Mount 30 detachably connects NVD 20 to helmet 10.

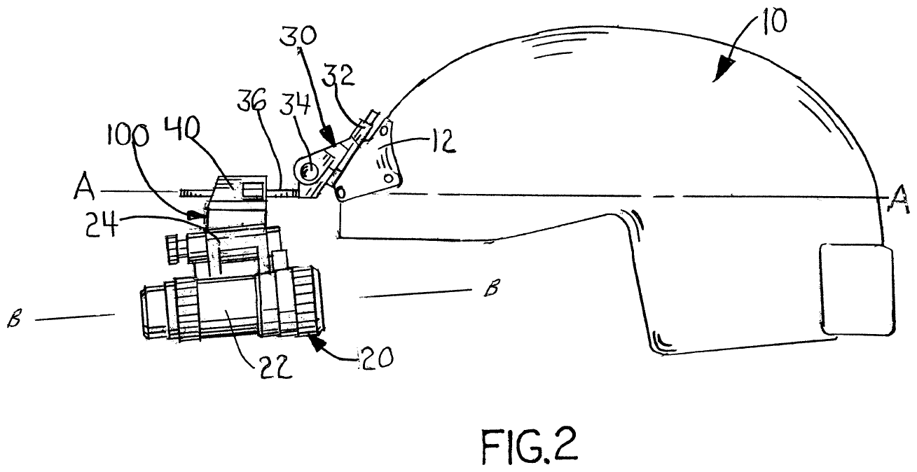

Mount 30 includes shroud interface 32 a pivot 34, rail 36 and a rail carriage 40. Mount 30 is the adjustable interface that allows the user to selectively position NVD 20 relative to the user's eyes and face. Pivot 34 allows the user to pivot NVD 20 between a stowed position above shroud 12 (not shown) and an operational position below the shroud (FIGS. 1 and 2). NVD 20 is detachably connected to the bottom of carriage 40. A shoe interface 50 detachably connects NGV 20 to the bottom of carriage 40, using a dovetail type mechanism (not shown). Shoe interface 50 has a rectangular body and is affixed, typically, to the body of the NVD by screw fasteners. Shroud interface 32 seats within shroud 12 and allows the user to adjust the height of NVD 20 below the shroud when in the operational position effectively raising and lowering axis A-A up and down. Carriage 40 rides along the length of rail 36 and allows user to move linearly NVD 20 along the longitudinal axis A-A of rail 36 toward and away from the user's eye when the NVD is in the operational position. As shown, the rectangular body of shoe interface 50 holds NVD 20 in position so that the NVD's line of sight remains parallel to the longitudinal axis A-A of rail 36 as carriage 40 moves along the rail.

The drawings illustrate several exemplary embodiments of the angled shoe interface of this invention. Each embodiment of the angled shoe interfaces of this invention is illustrated in the drawings for use as part of the conventional helmet mounted night vision setup of FIG. 1. As shown, the angled shoe interfaces of this invention provide a mechanical interface for connecting night vision devices to the sliding carriage of a conventional NVD mount. Each interface also has beveled shoulders that mate with the mount carriage to detachably secure the interface to the mount. More importantly, each of the angled shoe interfaces allows the user to selectively orient the NVD's line of sight relative to the longitudinal axis of the mount rail. Each angled shoe interface has a wedge-shaped body with differing angled top and bottom surfaces to provide the desired angular orientation of the line-of-sight B-B of NVD relative to the longitudinal axis A-A of the mount rail. Individual users can interchange different angled show interfaces based on the shape and size of the user's head and how the helmet is donned.

The angled shoe interfaces are separate components affixed directly to the night vision device. In other embodiments, the angled shoe interface may be affixed directly to the mount carriage. In addition, the angle shoe interface may be directly integrated into either the housing of the night vision device or the carriage. The angled shoe interfaces of this invention may be cast or machined from light weight metals, such as aluminum or molded from durable polymer materials.

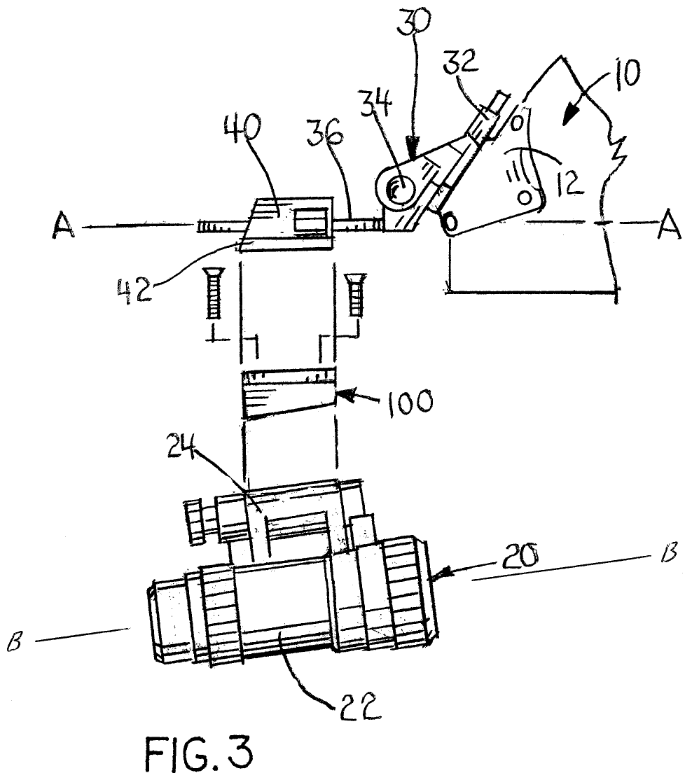

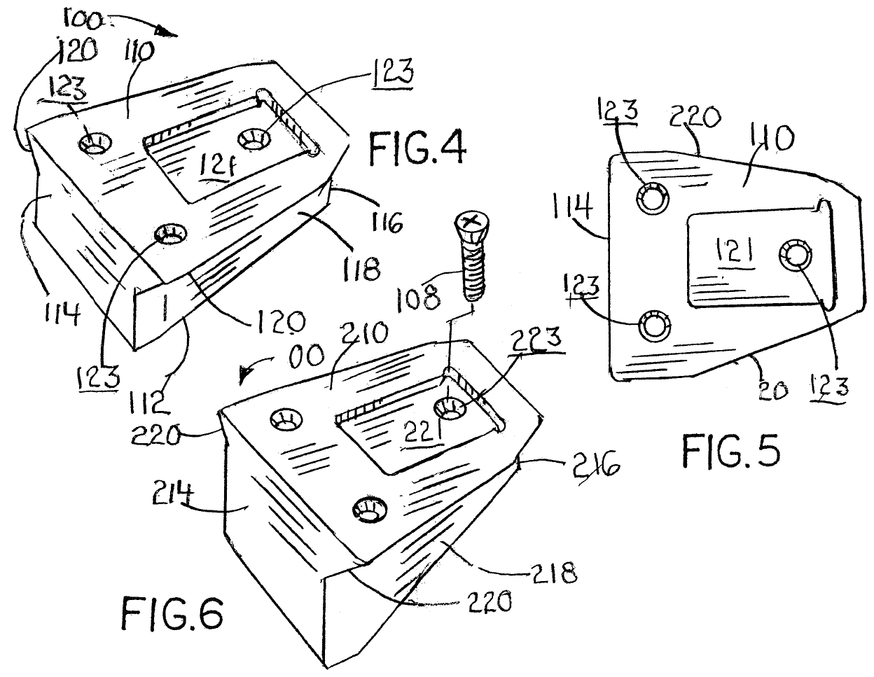

FIGS. 2-5 and 7-9 illustrate a first exemplary embodiment of the angled shoe interface of this invention, which is designated generally as reference numeral 100. Interface 100 has a solid wedge-shaped body defined by a top surface 110, bottom surface 112, front wall 114, end wall 116 and a pair of opposed side walls 118. Interface 100 also has a beveled shoulder 120 extending from both sidewalls 118 that mates with the bottom of carriage 40 to detachably secure the interface to the carriage. Top surface 110 has a recess 121 for receiving the latch component of carriage 40. Angle shoe interface 100 also has three countersunk bores 123 through which screw fasteners 108 secure the interface to the housing of NVD 20. As shown in FIGS. 4 and 7-8, front wall 114 is taller than rear wall 116 so that the planes of top surface 110 and bottom surface 114 converge toward the rear of interface 100. As shown in FIG. 2, angled shoe interface 100 connects NVD 20 to carriage 40 and orients the line-of-sight B-B through the NVD at an angle relative to the longitudinal axis A-A of rail 34.

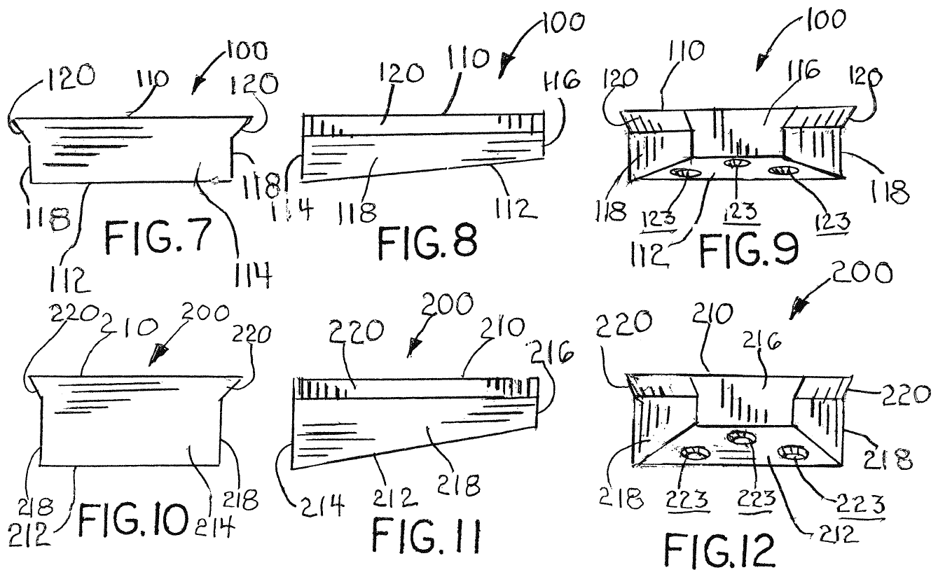

FIGS. 6 and 10-12 illustrate a second exemplary embodiment of the angle shoe interface of this invention, which is designated generally as reference numeral 200. Angled shoe interface 200 is identical in form, construction, and function as interface 100, above, except that the wedge-shaped body has a more angular configuration. Again, angled shoe interface 200 has a solid wedge-shaped body defined by a top surface 210, bottom surface 212, front wall 214, end wall 216 and a pair of opposed side walls 218. Interface 200 also has a beveled shoulder 220 extending from both sidewalls 218 that mates with the bottom of the carriage to detachably secure the interface to the carriage. Top surface 210 has a recess 221 for receiving the latch component of the mount carriage. Angled shoe interface 200 also has three countersunk bores 223 through which screw fasteners 108 secure the interface to the housing of NVD 20. As shown in FIGS. 10-12, front wall 214 is taller than rear wall 216 so that the planes of top surface 210 and bottom surface 214 converge toward the rear of interface 100. Angled shoe interface 200 connects the NVD to the mount carriage and orients the line-of-sight B-B through the NVD at a greater angle relative to the longitudinal axis A-A of the mount rail than interface 100.

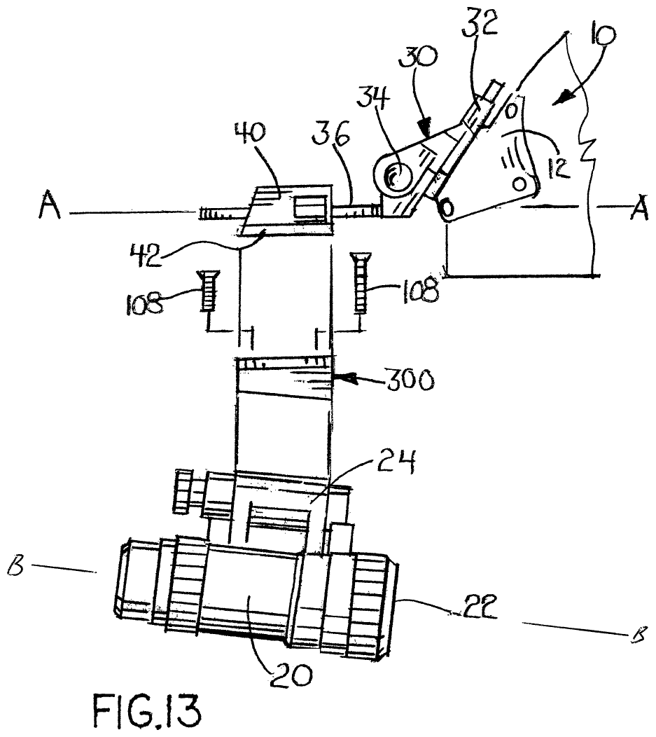

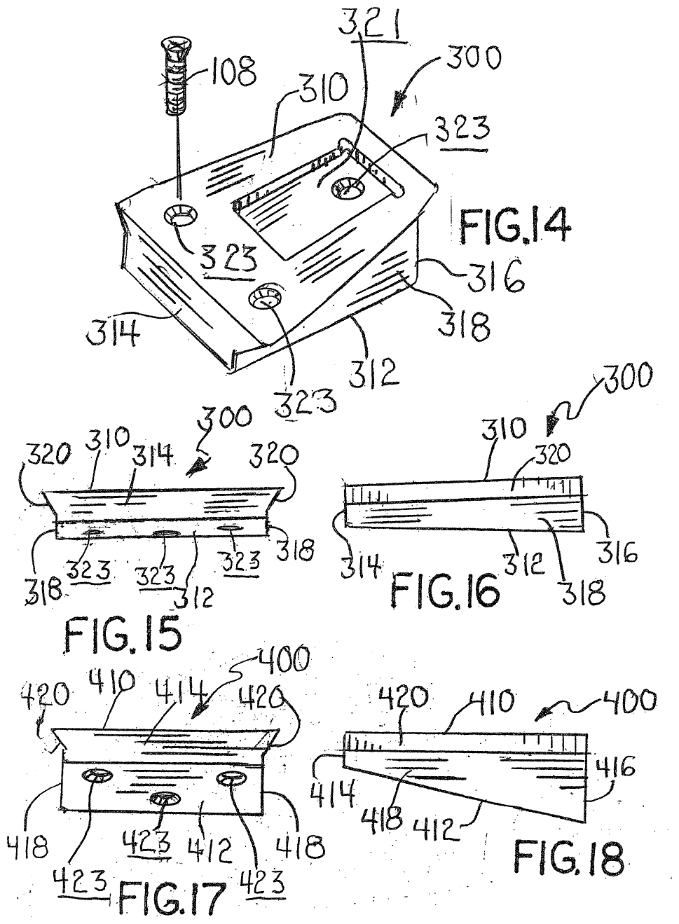

FIGS. 13-16 illustrate a third exemplary embodiment of the angled shoe interface of this invention, which is designated generally as reference numeral 300. Angled shoe interface 300 is identical in form, construction, and function as interface 100, above, except that the wedge-shaped body is an angular configuration opposite of interfaces 100 and 200 above. Again, angled shoe interface 300 has a solid wedge-shaped body defined by a top surface 310, bottom surface 312, front wall 314, end wall 316 and a pair of opposed side walls 318. Interface 300 also has a beveled shoulder 320 extending from both sidewalls 318 that mates with the bottom of the carriage to detachably secure the interface to the carriage. Top surface 310 has a recess 321 for receiving the latch component of the mount carriage. Angled shoe interface 300 also has three countersunk bores 323 through which screw fasteners 108 secure the interface to the housing of NVD 20. As shown in FIGS. 13-16, front wall 314 is shorter than rear wall 316 so that the planes of top surface 210 and bottom surface 214 diverge toward the rear of interface 100.

FIGS. 17-18 illustrate a fourth exemplary embodiment of the angled shoe interface of this invention, which is designated generally as reference numeral 400. Angled shoe interface 400 is identical in form, construction, and function as interface 300, above, except that the wedge-shaped body has a more angular configuration. Again, angled shoe interface 400 has a solid wedge-shaped body defined by a top surface 410, bottom surface 412, front wall 414, end wall 416 and a pair of opposed side walls 418. Interface 400 also has a beveled shoulder 420 extending from both sidewalls 418 that mates with the bottom of the carriage to detachably secure the interface to the carriage. Top surface 410 has a recess 421 for receiving the latch component of the mount carriage. Angled shoe interface 400 also has three countersunk bores 423 through which screw fasteners 108 secure the interface to the housing of NVD 20. Front wall 414 is shorter than rear wall 416 so that the planes of top surface 410 and bottom surface 214 diverge toward the rear of interface 400. Angled shoe interface 400 connects the NVD to the mount carriage and orients the line-of-sight B-B through the NVD at a greater angle relative to the longitudinal axis A-A of the mount rail than interface 300.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

1. A shoe interface for connecting a night vision device having a line of sight there through and night vision device mount, the night vision device having a line of sight there through and the mount includes a rail having a longitudinal axis and carriage shiftably mounted to the rail, the improvement comprising:
a wedge-shaped body connecting the carriage and the night vision device, such that the line or sight of the night vision device is oriented at a desired angle with respect to the longitudinal axis of the rail.

2. The interface of claim 1 wherein the wedge-shaped body is detachably connected to one of the night vision device and the night vision device mount.

3. The interface of claim 2 wherein the wedge-shaped body is affixed to the other of the night vision device and the night vision device mount.

4. The interface of claim 1 wherein the wedge-shaped body has a top surface and bottom surface, the top surface mates with and abuts against the carriage when the angled shoe interface is connected to the night vision device, the bottom surface mates with and abuts against the night vision device when the angled shoe interface is connected to the night vision device.

5. The interface of claim 4 wherein the top surface and the bottom surface are oriented with respect of one another to provide the desired angle.

6. In combination, a night vision device; a night vision device mount; and a plurality of angled shoe interfaces interconnecting the night vision device to the night vision device mount,
the night vision device having a line of sight there through,
the night vision device mount includes a rail having a longitudinal axis and carriage shiftably riding along the rail,
each of the plurality of angled shoe interfaces has a wedge-shaped body for connecting the carriage and the night vision device so that the line of sight of the night vision device is oriented at a plurality of differing angles with respect to the longitudinal axis of the rail.

7. The combination of claim 6 wherein each of the plurality of angled shoe interfaces is adapted to detachably connect to one of the night vision device and the night vision device mount.

8. The combination of claim 2 wherein the wedge-shaped body is adapted to affix to the other of the night vision device and the night vision device mount.

9. The combination of claim 6 wherein the wedge-shaped body of each of the plurality of the angled shoe interfaces has a top surface and bottom surface, the top surface mates with and abuts against the carriage when each of the plurality of angled shoe interfaces is connected to the night vision device, the bottom surface mates with and abuts against the night vision device when each of the plurality of the angled shoe interface is connected to the night vision device.

10. The improvement of claim 9 wherein the top surface and the bottom surface of the wedge-shaped body of each of the plurality of the angled shoe interfaces are oriented with respect to one another to provide the plurality of differing angles.
